(19) United States
(12) Patent Application Publication
(10) Pub. No.: US 2007/0080242 A1
(43) Pub. Date: Apr. 12, 2007

(54) Faucet side spray with metal plated exterior and interior structures, and with inert internal waterway

(76) Inventors: Xuedong Wang, Xiamen (CN); A'na Yan, Zhang Zhou (CN)

Correspondence Address: MCDERMOTT, WILL & EMERY LLP, 227 WEST MONROE STREET, CHICAGO, IL, 60606-5096, US

(21) Appl. No.: 11/247,663

(22) Filed: Oct. 11, 2005

(51) Int. Cl. B05B 9/01

(52) U.S. Cl. 239/526; 239/583

(57) ABSTRACT

A kitchen deck side spray assembly for attachment to a water hose, including a spray body having an outer surface and an inner surface, the spray body being plated with a metal on both its inner and outer surfaces; and an inert water conduit, the inert water conduit being substantially enclosed by that spray body.

### TECHNICAL FIELD

The invention relates to a kitchen side spray assembly that prevents the leaching of deleterious and potentially toxic substances into the water that passes through that assembly.

### BACKGROUND OF THE INVENTION

Side spray assemblies are well known in the prior art. Typically, these side spray assemblies are for use at the top of a kitchen sink. Municipal water is fed to the bottom of the side spray assemblies through a long, flexible hose. The side spray assembly can be pulled away from the top of the sink, so that the side spray assembly can deliver water at a point closer to the utensils or dishes that are to be cleaned by that device.

Some conventional side spray units are plated with a metal on their inner and outer surfaces. Plating of the interior is not aesthetically necessary or desirable. It occurs, however, because the plating process requires that the entire head of the side spray assembly be immersed into the bath of molten plating metal.

As water passes through these conventional prior art side spray units, the water passes by and contacts the plated inner surfaces. This contact can result in the passage of potentially toxic chemicals from the plated surface into that water. If sufficient amounts of such toxic chemicals are shown to have leached into such water, these prior art side spray units will fail to pass the necessary National Sanitation Foundation (NSF) testing.

Examples of prior art side spray assemblies are shown in many United States patents. Among these patents is U.S. Pat. No. 6,641,060 to Brattoli et al. The Brattoli patent includes a spray body 10 and a water tube 20. Water enters the spray body 10 through the water tube 20. The construction of the unit of the Brattoli patent permits the spray body 10 to be readily replaced, from above the sink deck, and without disconnecting below-deck plumbing pipes or fittings. However, the water tube 20 does not appear to carry water from the inlet of the spray body 10, and through the outlet of the spray body 10.

Another prior art side spray assembly is shown in United States Patent Application Publication No. US 2005/0145725 A1. However, the device shown in this application does not include metallized or metal-plated water passages. Rather, both the body 10 and the water channel 12 within that body 10 through which the water flows are apparently made of an injection-molded polymer.

A third prior art side spray assembly is shown in U.S. Pat. No. 6,808,130 B1. This side spray assembly includes a base holder 11 and an inner tube 13. The water enters the base holder 11 through the inner tube 13. The relationship between this base holder 11 and this inner tube 13 is shown in the exploded diagram of the patent, FIG. 1. The inner tube 13 does not, however, act as a conduit for the flow of the water between the inlet and the outlet of the base holder 11. Particularly, as may also be seen in FIG. 1, after water is discharged from the top of the inner tube 13, it moves through the adapter 12 and the spout 80 of the spray head.

A fourth prior art side spray assembly is shown and described in U.S. Pat. No. 5,662,276. While municipal water enters this side spray unit through a so-called water hose 50, that water then moves into a long pipe section 12. In this way, the device of the '276 patent is very similar to the internally and externally plated side spray assemblies of the prior art.

Other generally relevant patents include U.S. Pat. Nos. 6,641,061; 6,561,441; 6,173,910; 5,971,299; 4,927,115; and United States Patent Application Publication No. US 2003/0001028 A1.

The present invention is intended to solve the problems discussed above and other problems, and to provide advantages and aspects not provided by prior art spray heads of this type. A full discussion of the features and advantages of the present invention follows, in the specification, and in the accompanying drawings.

### SUMMARY OF THE INVENTION

The invention is a side spray assembly, typically for use at the top of a kitchen sink. A long, flexible hose acts as the means to feed municipal or well water to the bottom of side spray assemblies of this kind. The side spray assembly can be pulled away from the top of the sink, so that the side spray assembly can more easily deliver water at a point closer to the utensils or dishes that are to be cleaned or sprayed by that assembly.

As background, some conventional side spray units are plated with a metal on their inner and outer surfaces. As water passes through such plated side spray units, the contact of water with the plated inner surfaces can result in the passage, from the plated surface into the water, of potentially toxic chemicals. If sufficient amounts of such toxic chemicals are shown to have leached into such water, these prior art side spray units will fail to pass the necessary National Sanitation Foundation (“NSF”) testing

In particular, the invention is a kitchen deck side spray assembly for attachment to a water hose. The side spray assembly includes a spray body having an outer surface and an inner surface. The spray body further includes a water inlet port and a water outlet port.

The spray body is plated with a metal on both its inner and outer surfaces. In an alternate embodiment, the spray body may be made completely of metal.

The side spray assembly further includes an inert water conduit. The inert water conduit has an inlet end and an outlet end.

The inert water conduit is substantially enclosed by that spray body.

In one embodiment of the invention, the inert water conduit is comprised of a first piece and a second piece.

In another embodiment of the invention, the inert water conduit is comprised of a first piece, a second piece, and a third piece.

Preferably, the inert water conduit is made of a polymeric material. A most preferred inert polymer material is acrylonitrile butadiene styrene

In one embodiment of the kitchen deck side spray assembly, the first piece and second piece are connected with at least one rubber O-ring.

In another embodiment of the kitchen deck side spray assembly, the first piece and second piece are connected with at least one rubber O-ring, and the second piece and third piece are connected with at least one rubber O-ring.

Another aspect of the kitchen deck side spray assembly comprises a tab upon the inert conduit, and a corresponding slot upon the spray body. The slot is positioned upon the spray body for engagement with the tab. In this way, the inert conduit may be securely mounted to the spray body.

A still further aspect of the kitchen deck side spray assembly comprises a slot upon the inert conduit, and a corresponding tab upon the spray body. The tab is positioned upon the spray body for engagement with the slot of the inert conduit. In this way, the inert conduit may be securely mounted to the spray body.

In summary, then, in the present invention, the water is moved through the inert water conduit of the side spray unit, rather than along an unprotected, inner plated surface of the side spray unit. In this way, the inert water conduit prevents the water from contacting the plated inner surface, as may occur in certain prior art side spray units.

Other features and advantages of the invention will be apparent from the following specification, taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a first embodiment of the invention;

FIG. 2 is a cross-sectional view, taken along lines 2-2 of FIG. 1, of the embodiment of FIG. 1;

FIG. 3 is a perspective view of the inert water conduit of the embodiment of FIGS. 1 and 2, but without the water inlet port;

FIG. 4 is a perspective view of a second embodiment of the invention;

FIG. 5 is a cross-sectional view, taken along lines 5-5 of FIG. 4, of the embodiment of FIG. 4;

FIG. 6 is a perspective view of the inert water conduit of the second embodiment of FIG. 4, but without the handle and water valve; and

FIG. 7 is an exploded view of the components of the embodiment of FIGS. 4-6.

### DETAILED DESCRIPTION

This invention is susceptible of embodiments in many different forms. The drawings show and the specification describes the invention in detail. It should be understood that the below disclosure is to be considered as an example of the principles of the invention. This disclosure is not intended to limit the broad aspect of the invention to the embodiments illustrated.

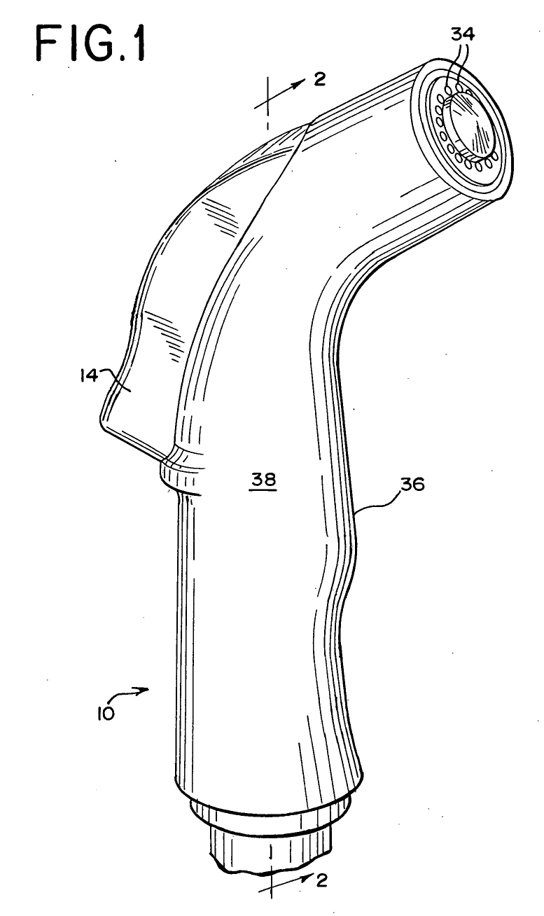

As may be seen in FIGS. 1-6, and initially in the three-piece, first embodiment of FIGS. 1-3, the invention is a side spray assembly 10, typically for use at the top of a kitchen sink. As may best be seen in FIG. 3, a long, flexible hose 12 acts as the means to feed municipal water to the bottom of side spray assemblies 10 of this kind. This side spray assembly 10 is typical in many ways, including in general appearance, and in the way it is actuated.

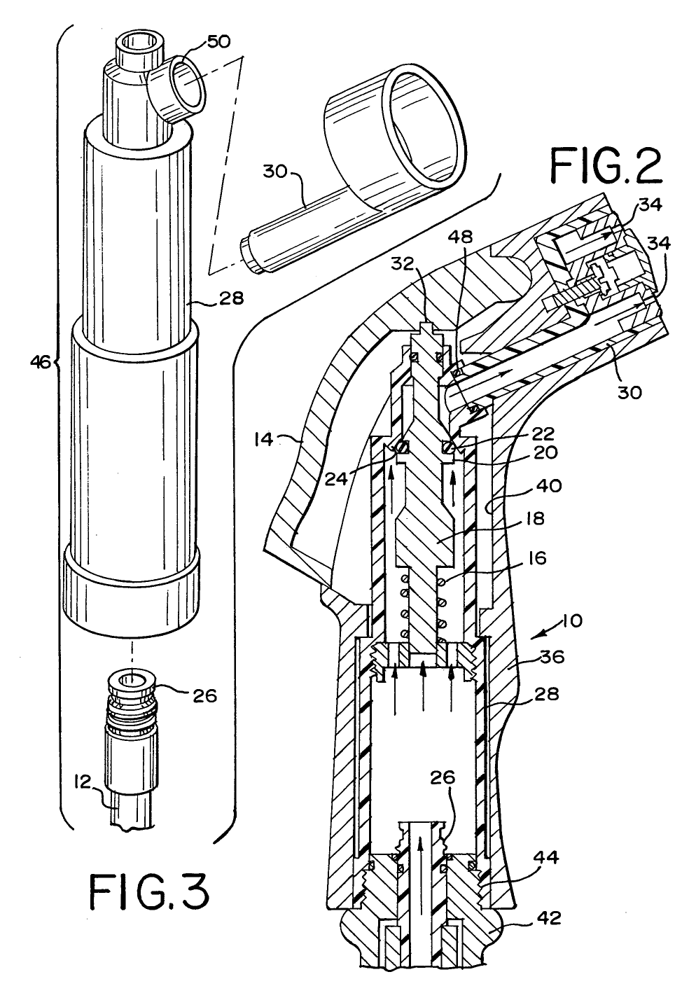

As may best be seen in FIG. 2, the side spray assembly 10 includes, as a separate element, a spring-loaded actuator or trigger 14. Normally, this trigger 12 is biased outwardly by an affiliated spring. In this embodiment, that spring 16 is shown surrounding a water valve element 18.

When the trigger 12 is in the normal position of FIG. 3, the affiliated spring 16 maintains the internal water valve in its closed position. In this closed position, a circumferential shoulder 20 retains an O-ring 22 against a shoulder 24 of the so-called second piece 28. In this position, the abutment of the O-ring 22 against the shoulder 24 prevent water from flowing through the side spray assembly 10.

Alternatively, when a user wishes to dispense water from the side spray assembly 10, this trigger 14 is pressed and pivoted inwardly, and towards the axial center of the side spray assembly 10. Upon such inward movement, the trigger 14 pushes downwardly upon a stem 32 at the top of the water valve 18. As a result, the water valve 18 is moved downwardly within the second piece 28, compressing the affiliated spring 16. As the water valve 18 is moved downwardly, the O-ring 22 is moved away from the shoulder 24. This movement of the O-ring 22 away from the shoulder 24 opens a channel between the exterior of the water valve 18 and the interior of the second piece 28. When this channel is opened, water from the long flexible hose 12 can now move through the side spray assembly 10, and out of orifices 34 at the discharge end of the side spray assembly 10. The direction and path of the water flowing through the side spray assembly 10 is depicted by the arrows of FIG. 2.

Upon the release of the trigger 14, the compressed spring 16 expands, forcing the water valve 18 upwardly and to its original position, as shown in FIG. 2. When in this position, the valve 18 is closed, and water from the long flexible hose 12 is again prevented from flowing through the side spray assembly 10.

As a result of the long flexible hose 12 attached to the bottom of the side spray assembly 10, that assembly 10 may be pulled away from the top surface of the sink (not shown). In this way, the side spray assembly 10 can be positioned to more easily deliver water to a point closer to the utensils or dishes that are to be cleaned or sprayed by that assembly 10.

As indicated above, some conventional side spray units are plated with a metal on their inner and outer surfaces. As water passes through such plated side spray units, the contact of water with the plated inner surfaces can result in the passage, from the plated surface into the water, of potentially toxic chemicals. If sufficient amounts of such toxic chemicals are shown to have leached into such water, these prior art side spray units will fail to pass the necessary National Sanitation Foundation (“NSF”) testing

The present invention, in contrast, prevents the leaching of such toxic chemicals into the water passing through the side spray assembly 10.

In the three-piece embodiment of FIGS. 1-3, and especially FIGS. 2 and 3, the side spray assembly 10 includes a main structural portion, referred to as the spray body 36. The spray body 36 is typically made of an NSF certified polymer, including but not limited to polyoxymethylene (“POM”). The spray body 36 is typically molded in one piece.

This spray body 36 encloses, or acts as a base for the attachment of, all of the various components of the side spray assembly 10, including but not limited to the trigger 14.

As may best be seen in FIG. 1, the exterior of the spray body 36 includes a plated outer surface 38. In addition, as may best be seen in FIG. 2, the interior of the side spray assembly 10 includes a plated inner surface 40.

The spray body 36 may be plated with any of a variety of different metals. Preferred metals depend upon the finish desired by the manufacturer, and include chromium or brass or any other suitable plating metal.

Plated outer surface 38 is plated intentionally, and primarily for aesthetic reasons. In contrast, plated inner surface 40 is plated primarily as a result of the manufacturing process. Particularly, in order to plate the spray body 36, the entire spray body 36 is dipped into a liquid metal bath. Accordingly, the chromium or brass or other metal is plated on both the outer 38 and inner 40 surfaces of the spray body 36.

In an alternate embodiment, however, the spray body 36 may be made completely of a metal.

As may be seen in FIG. 2, at its bottom, the spray body 36 includes a water inlet port 42. The water inlet port 42 is typically connected to the long, flexible hose 12 that acts as the means to feed municipal or well water to the bottom of side spray assembly 10

As may best be seen in FIG. 2, the water inlet port 42 includes an externally threaded portion 44.

In order to prevent contact of the water moving through the spray body 36 with its plated inner surface 40, the side spray assembly 10 encloses and includes an inert water conduit 46. This inert water conduit 46 may best be seen in the sectional view of FIG. 2, and in the perspective view of FIG. 3. In this embodiment, the inert water conduit 46 is made of three main pieces.

The inert water conduit 46 can be made of any suitable material, such as a polymeric material. Most preferred polymeric materials include either polyoxymethylene (POM) or acrylonitrile butadiene styrene (ABS).

While the present embodiment includes a three-piece structure, this inert water conduit 46 can be of a fewer pieces, or a single piece, or it can be fabricated from a number of pieces.

The inert water conduit 46 is separately formed from the spray body 36. After plating of the spray body 36, the inert water conduit 46 is inserted separately into that spray body 36.

After its insertion into the spray body 36, the inert water conduit 46 is substantially enclosed by that spray body 36.

When the water conduit 46 is enclosed within the spray body 36, it is positioned to transport water through the spray body 36, without that water touching the plated inner surfaces 40 of that spray body 36. In this way, it is not possible for any toxic chemicals that may be found in the plating on the plated inner surface 40 of the spray body 36 to leach into the water being transported through that spray body 36.

As indicated above, the path of the water moving through the spray body 36, and its direction of flow, are depicted by arrows in FIG. 2.

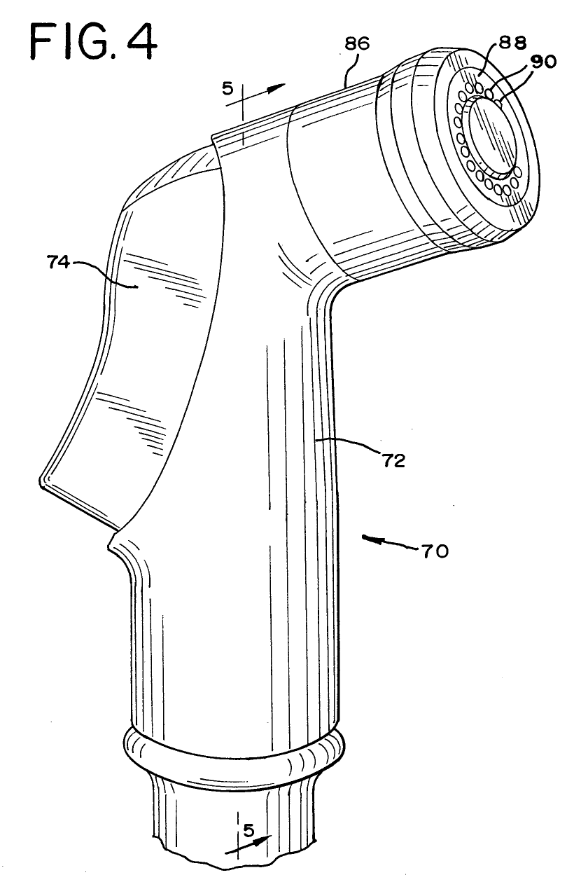

In the second embodiment of the invention, as shown in FIGS. 4-7, the path of the water moving through that spray body, and its direction of flow, are also depicted by the arrows in this FIG. 5.

Returning again to the first embodiment of the side spray assembly, as shown in FIGS. 1-3, the inert water conduit 46 is made of three pieces. As may best be seen in FIG. 2, the first piece 26, the second piece 28, and the third piece 30 are interconnected. In the embodiment of FIGS. 1-3, the first piece 26 is connected to the second piece 28 by attaching the second piece 28 to the externally threaded portion 44 of the water inlet port 42.

In this same embodiment, the second piece 28 is connected to the third piece 30 with at least one rubber O-ring 48. This O-ring 48 is contained within an upper opening 50 of the second piece 28. When the smaller diameter end of the third piece 30 is inserted into the upper opening 50 of the second piece 28, a water tight connection is created between the second piece 28 and the third piece 30, by virtue of the O-ring 48.

As may be seen from the sectional view of FIG. 2, the third piece 30 is retained within the spray body 36 by virtue of a frictional fit. Particularly, third piece 30 slides into an opening within the spray body 36 that has a shape that is complementary to the shape of the third piece 30.

When the third piece 30 is fully seated within this complementary opening of the spray body 36, the leftmost end of the third piece 30, i.e., the end having the smaller diameter, and the upper opening 50 of second piece 28, are positioned such that the O-ring 48 creates a water-tight seal between the second piece 28 and third piece 30.

As noted above, the second embodiment of the side spray assembly 70 is shown in FIGS. 4-6.

This second embodiment includes a spray body spray body 72 and a trigger 74. Spray body 72 and trigger 74 are both plated, in the same manner as the plating of the spray body 36 and trigger 14 of the first embodiment shown in FIGS. 1-3. As in the embodiment of FIGS. 1-3, the spray body 72 and the trigger 74 include plated outer and inner surfaces.

As may best be seen in FIGS. 5, 6, and 7, in this embodiment, the side spray assembly 70 has an inert water conduit 76 that is comprised of two pieces. Particularly, this second embodiment includes a first piece 78 and a second piece 80.

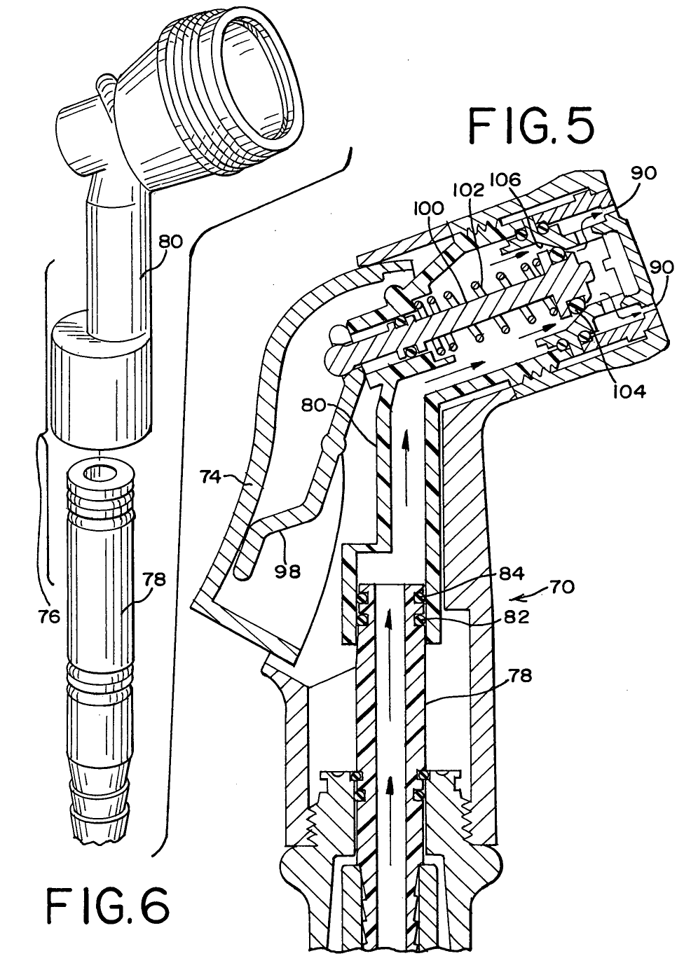

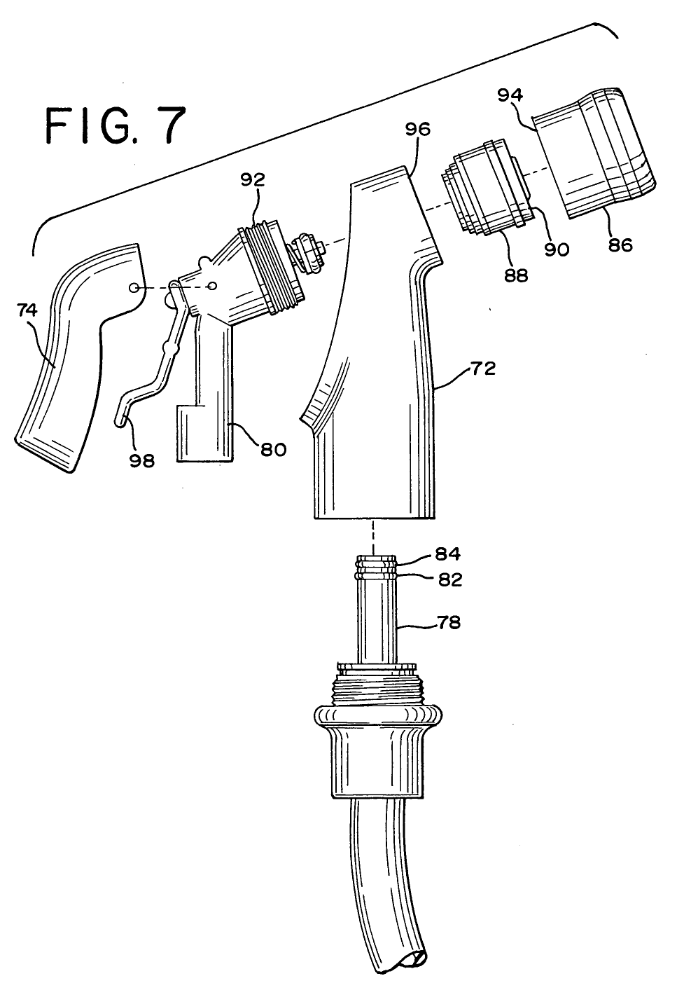

As may be seen in FIGS. 6 and 7, the first piece 78 is connected to the second piece 80 with an O-ring 82 and an O-ring 84. Although two O-rings 82 and 84 are shown, it is possible to connect the first piece 78 and the second piece 80 with a single O-ring.

As alluded to above, in the context of this application, and for both of the above two embodiments, the term “connected” means that the rubber O-ring is (or the rubber O-rings are) positioned between the first piece and the second piece, and/or between the second piece and third piece, to create a water-tight seal. The term “connected” does not mean that the two or three pieces are rigidly connected, by virtue of the O-rings, to each other. In both of the embodiments of the invention, the first, second, and third pieces are held in their proper positions, relative to each other, by virtue of their retention within the spray bodies 36 and 72, or by attachment to other elements, such as attachment to the water inlet port 42.

In the embodiment of FIGS. 4-7, the side spray assembly includes a separate, threaded cap 86. The cap 86 is internally threaded. The cap 86 contains a cup-shaped, polymeric nozzle element 88 with a plurality of discharge orifices 90 through which the water is discharged.

The inner threads of this threaded cap 86 are secured to a complementarily threaded portion 92 of the second piece 80. When the threaded cap 86 is fully threaded onto the threaded portion of the second piece 80, one end 94 of the threaded cap 86 abuts against an adjacent end 96 of the spray body 72.

When the threaded cap 86 is fully and completely threaded in this manner onto the threaded portion 92 of the second piece 80, as may best be seen in FIGS. 4 and 5, the second piece 80 secures the threaded cap 86 to the spray body 72. In a similar manner, when in the position shown in FIGS. 4 and 5, the threaded cap 86 provides stability and securement of the second piece 80 within the spray body 72.

Referring now to FIGS. 5 and 7, the second piece 80 includes a handle 98. When the user pushes on the trigger 74, the inner surface of this trigger 74 contacts the handle 98 and moves that end of that handle 98 towards the main body of the second piece 80, i.e., to the right in FIG. 7. That handle is connected to a water valve 100.

That water valve 100 includes a spring 102. The water valve 100 also includes, near its tip, a trapped O-ring 104.

The threaded cap 86 includes a seating surface 106, i.e., a seat 106. The O-ring 104 of the water valve 100 contacts the seat 106, when these elements are positioned as shown in FIGS. 5 and 6. When the O-ring 104 contacts the seat 106, water cannot be moved through the side spray assembly 70.

In contrast, when the trigger 74 is pressed by the user, it contacts the end of the handle 98. The water valve 100 is moved to the left, the spring 102 is compressed, and the O-ring 104 moves away from the seating surface 106. When the O-ring 104 is positioned away from the seating surface 106 in this manner, water can move through the entire spray body 72, and out of the side spray assembly 70 through nozzle 88 and discharge orifices 90.

In summary, then, in both embodiments of the invention, the water is moved through the inert water conduit within the spray body of the side spray assembly, rather than along an unprotected inner plated surface f the spray body. The inert water conduit thereby prevents the water from contacting the plated inner surface, as occurs in certain ordinary, prior side spray units.

A still further advantage of the invention is that the inert water conduit acts as an insulator, and moderates the temperature of the outside surface of the spray body caused by the movement of very hot or very cold water through that spray body. This has two advantages.

First, the moderated temperature on the outside of the spray body resulting from the insulating effect of this inert water conduit makes the spray body more comfortable in the hands of the users of the side spray assembly.

Second, in prior art units, very cold water, and then very hot water, and then very cold water again, can alternatively be moved through the side spray units, within a short period of time. The rapid, repeated extreme changes in the temperature of the water moving through the side spray units creates a thermal stress on the plated outer surface of those side spray units. Over time, such repeated thermal stresses can compromise the bond between the plating and the base of the side spray unit, and cause that plating to chip and flake. This results in a very unsightly and aesthetically unpleasing condition. A consumer experiencing such chipping and flaking is far less likely to again purchase the side spray unit of that particular manufacturer.

The present invention provides an insulating effect, and reduces the wide fluctuations in temperature on the outer surface of the spray body of the side spray assembly. As a result, extreme thermal stresses are avoided, and the chipping or flaking of the plating on the spray body is reduced or eliminated.

While the specific embodiments have been illustrated and described, numerous modifications come to mind without significantly departing from the spirit of the invention, and the scope of protection is only limited by the scope of the accompanying Claims.

What is claimed is:

1. A kitchen deck side spray assembly for attachment to a water hose, including:
(a) a spray body having an outer surface and an inner surface, the spray body being plated with a metal on both its inner and outer surfaces; and
(b) an inert water conduit, the inert water conduit being substantially enclosed by that spray body, wherein the water that passes through the spray body avoids contact with the inner surfaces of that spray body, by movement through the inert water conduit.

2. The kitchen deck side spray assembly of claim 1, wherein the inert water conduit is comprised of a first piece and a second piece.

3. The kitchen deck side spray assembly of claim 1, wherein the inert water conduit is comprised of a first piece, a second piece, and a third piece.

4. The kitchen deck side spray assembly of claim 1, wherein the inert water conduit is made of a polymeric material.

5. The kitchen deck side spray assembly of claim 1, wherein the inert water conduit is made of acrylonitrile butadiene styrene.

6. The kitchen deck side spray assembly of claim 2, wherein the first piece and second piece are connected with at least one rubber O-ring.

7. The kitchen deck side spray assembly of claim 3, wherein the first piece and second piece are connected with at least one rubber O-ring, and wherein the second piece and third piece are connected with at least one rubber O-ring.

8. A kitchen deck side spray assembly for attachment to a water hose, including:
(a) a spray body having an outer surface and an inner surface, the spray body being plated with a metal on both its inner and outer surfaces;
(b) an inert water conduit, the inert water conduit being substantially enclosed by that spray body, wherein the water that passes through the spray body avoids contact with the inner surfaces of that spray body, by movement through the inert water conduit;
(c) the inert water conduit comprising a first piece and a second piece, wherein the second piece includes a water valve for alternatively restricting and permitting the flow of water through the kitchen deck side spray assembly.

9. The kitchen deck side spray assembly of claim 8, wherein that water valve includes a biasing spring for returning that water valve to a position wherein that valve restricts the flow of water.

10. The kitchen deck side spray assembly of claim 8, wherein the water valve includes an O-ring at the end of the water valve, that O-ring facilitating the closing and opening of a channel for the passing of water through the side spray assembly

11. The kitchen deck side spray assembly of claim 8, wherein the spray body includes a threaded cap at one of its proximate ends.

12. The kitchen deck side spray assembly of claim 11, wherein the threaded portion of the threaded cap is engaged, with complementary threads on the second piece, so as to secure the second piece within the valve body.
